(19) United States
(12) Patent Application Publication
(10) Pub. No.: US 2023/0028676 A1
(43) Pub. Date: Jan. 26, 2023

(54) LOCATION DETERMINATION OF DEPLOYED FIBER CABLES USING DISTRIBUTED FIBER OPTIC SENSING

(71) Applicant: NEC Laboratories America, Inc., Princeton, NJ (US)

(72) Inventors: Ming-Fang HUANG, Princeton, NJ (US); Shaobo HAN, Princeton, NJ (US); Ting WANG, Princeton, NJ (US); Yuheng CHEN, South Brunswick, NJ (US); Yangmin DING, East Brunswick, NJ (US); Yue TIAN, Princeton, NJ (US); Sarper OZHARAR, Princeton, NJ (US)

(73) Assignee: NEC LABORATORIES AMERICA, INC, Princeton, NJ (US)

(21) Appl. No.: 17/871,816

(22) Filed: Jul. 22, 2022

Related U.S. Application Data
(60) Provisional application No. 63/224,973, filed on Jul. 23, 2021.
(60) Provisional application No. 63/225,004, filed on Jul. 23, 2021.
(60) Provisional application No. 63/225,011, filed on Jul. 23, 2021.

(51) Int. Cl. G01H 9/00

(52) U.S. Cl. CPC G01H 9/004; G01D 5/35358

(57) ABSTRACT

Systems and methods for determining fiber optic facility (cable) location using distributed fiber optic sensing (DFOS) and sequence pattern matching of vibration excitation signals applied to a sensor fiber. The use of sequence pattern matching with unique pattern codes allow for the precise determination of location and length of deployed fiber cable while exhibiting an immunity from environmental vibrations proximate to the fiber. As a result improved measurements are realized and false alarms are eliminated.

### CROSS REFERENCE TO RELATED APPLICATIONS

This application claims the benefit of Untied States Provisional Patent Application Ser. No. 63/224,973 filed 23 Jul. 2021, Untied States Provisional Patent Application Ser. No. 63/225,004 filed 23 Jul. 2021, and Untied States Provisional Patent Application Ser. No. 63/225,011 filed 23 Jul. 2021, the entire contents of each is incorporated by reference as if set forth at length herein.

### TECHNICAL FIELD

This disclosure relates generally to optical fiber telecommunications facilities. More particularly, it describes systems and methods for location determination of deployed fiber cables using distributed fiber optic sensing (DFOS).

### BACKGROUND

As is known, contemporary telecommunications make extensive use of fiber optic facilities that advantageously provide communications bandwidth(s) and services for an ever-increasing demand. Its importance in contemporary society cannot be overstated. As a result, damage to such facilities and resulting service outages are most disruptive.

When a deployed fiber optic cable or other facility experiences a fault (e.g., a fiber cut), one or more members of a service team may be deployed to correct the fault. To correct such fault, the service team must identify a location of the fault. As a result, determining the location of the fiber optic facility—quickly—is of critical importance and systems and methods that facilitate such location determination would represent a welcome addition to the art.

### SUMMARY

An advance in the art is made according to aspects of the present disclosure directed to systems, and methods for determining fiber optic facility (cable) location. Accordingly, illustrative methods according to the present disclosure identify the location of deployed fiber cable using distributed fiber optic sensing (DFOS) by providing a distributed fiber optic sensing system (DFOS), said system including a length of optical sensor fiber; and a DFOS interrogator and analyzer in optical communication with the length of optical fiber, said DFOS interrogator configured to generate optical pulses from laser light, introduce the pulses into the optical fiber and detect/receive Rayleigh reflected signals from the optical fiber, said analyzer configured to analyze the Rayleigh reflected signals and generate location/time waterfall plots from the analyzed Rayleigh reflected signals; a sequencer and pattern supervisor configured to create sequence patterns and provide the created sequence patterns to a mechanical vibrator; operating the mechanical vibrator at a location along the length of optical fiber, the mechanical vibrator configured to receive the created sequence patterns and generate mechanical vibrations according to the received sequence pattern, apply the generated mechanical vibrations to the optical fiber, and determine the global positioning location (GPS) location of the mechanical vibrator during operation and transmit GPS coordinates and time stamp information to the DFOS interrogator and analyzer; operating the DFOS system while providing the generated mechanical vibrations to the optical fiber thereby producing vibration events in the optical fiber and recording DFOS signals received during operation while associating optical fiber location to GPS coordinates and time stamp information received from the mechanical vibrator.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system according to aspects of the present disclosure;

FIG. 2 is a schematic diagram showing an illustrative system layout of a sensing layer overlaid on an existing deployed optical fiber according to aspects of the present disclosure;

FIG. 3 is schematic diagram showing illustrative sequence patterns generated by a pattern supervisor and sending to a field vibrator according to aspects of the present disclosure;

FIG. 4 shows a series of plots showing illustrative examples of field noise patterns according to aspects of the present disclosure;

FIG. 5 is a plot showing an illustrative example of sequence pattern #1 of FIG. 4 according to aspects of the present disclosure;

FIG. 6 is a schematic flow diagram showing an illustrative pattern recognizer according to aspects of the present disclosure;

FIG. 7(A)-FIG. 7(H) are a series of detecting patterns from waterfall data in which FIG. 7(A) contains 6 target patterns; FIG. 7(B) shows time series before and after truncation; and cross correlation up to lag=200 is shown in FIG. 7(C)-FIG. 7(H) according to aspects of the present disclosure;

FIG. 8 is a schematic flow diagram showing an illustrative process according to aspects of the present disclosure;

FIG. 9 is a schematic diagram showing an illustrative system layout of a sensing layer overlaid on an existing deployed optical fiber according to aspects of the present disclosure according to aspects of the present disclosure;

FIG. 10 is a schematic diagram illustrating a method according to aspects of the present disclosure;

FIG. 11 (A)-FIG. 11(D) are plots illustrating field testing results according to aspects of the present disclosure;

FIG. 12(A) is a schematic diagram illustrating system operation according to aspects of the present disclosure;

FIG. 12 (B) is a schematic diagram illustrating acousto-vibration correlation cable localization method according to aspects of the present disclosure; and

FIG. 13 is a schematic flow diagram showing an illustrative process according to aspects of the present disclosure;

FIG. 14 is a schematic block diagram showing an illustrative features of a method according to aspects of the present disclosure;

FIG. 15 is a schematic block diagram showing illustrative features and relationships of a process according to aspects of the present disclosure;

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Fiber optic sensing measures changes in “backscattering” of light occurring in an optical sensing fiber when the sensing fiber encounters vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

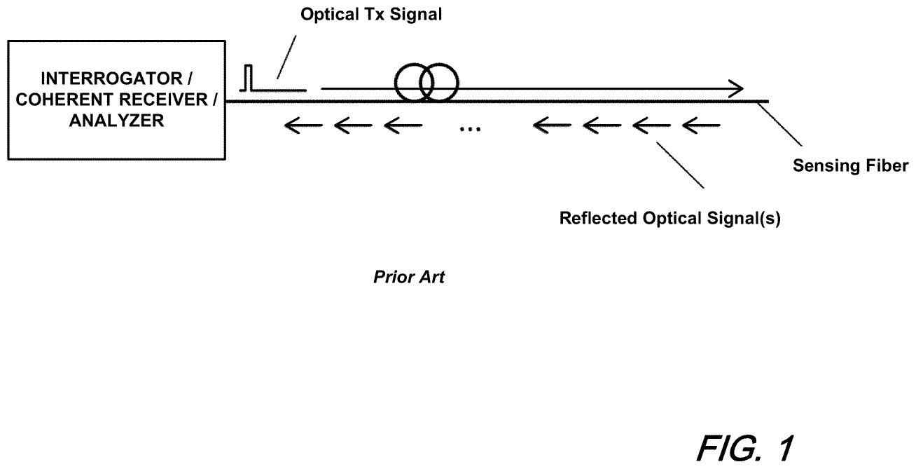

A schematic diagram illustrating the generalized arrangement and operation of a distributed fiber optic sensing system including artificial intelligence analysis and cloud storage/service is shown in FIG. 1. With reference to FIG. 1 one may observe an optical sensing fiber that in turn is connected to an interrogator. As is known, contemporary interrogators are systems that generate an input signal to the fiber and detects/analyzes reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes the interrogator that periodically generates optical pulses (or any coded signal) and injects them into an optical fiber. The injected optical pulse signal is conveyed along the optical fiber.

At locations along the length of the fiber, a small portion of signal is scattered/reflected and conveyed back to the interrogator. The scattered/reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Distributed Acoustic Sensing (DAS)/Distributed Vibrational Sensing (DVS) systems detect vibrations and capture acoustic energy along the length of optical sensing fiber. Advantageously, existing, traffic carrying fiber optic networks may be utilized and turned into a distributed acoustic sensor, capturing real-time data. Classification algorithms may be further used to detect and locate events such as leaks, cable faults, intrusion activities, or other abnormal events including both acoustic and/or vibrational.

Various DAS/DVS technologies are presently used with the most common being based on Coherent Optical Time Domain Reflectometry (C-OTDR). C-OTDR utilizes Rayleigh back-scattering, allowing acoustic frequency signals to be detected over long distances. An interrogator sends a coherent laser pulse along the length of an optical sensor fiber (cable). Scattering sites within the fiber cause the fiber to act as a distributed interferometer with a gauge length like that of the pulse length (e.g. 10 meters), Acoustic/mechanical disturbance acting on the sensor fiber generates microscopic elongation or compression of the fiber (micro-strain), which causes a change in the phase relation and/or amplitude of the light pulses traversing therein.

Before a next laser pulse is be transmitted, a previous pulse must have had time to travel the full length of the sensing fiber and for its scattering/reflections to return. Hence the maximum pulse rate is determined by the length of the fiber. Therefore, acoustic signals can be measured that vary at frequencies up to the Nyquist frequency, which is typically haft of the pulse rate. As higher frequencies are attenuated very quickly, most of the relevant ones to detect and classify events are in the lower of the 2 kHz range.

As we shall show and describe and as already noted, our inventive systems and methods automatically detect/interpret vibration signals resulting from DFOS operation using deployed fiber optic sensor cables to detect/locate cable vibrations and determine cable locations therefrom.

As those skilled in the art will understand and appreciate—for fiber optic cable location identification, fiber optics technicians and service personnel generally use optical time-domain reflectometer (OTDR) systems and methods to measure a fiber length and loss. However, these methods do not accurately to help technicians identify locations of a deployed fiber cable since the OTDR measurement does not provide a location on a geographic map, due in part to slack in cables along the length of the cable.

To facilitate location determination of fiber optic cable location we describe herein a novel, patterns-based method for identifying location(s) of deployed fiber optic cables. Our method advantageously employs distributed fiber optic sensing technology. Operationally, a unique on/off vibration pattern is generated by a vibrator which can advantageously be automatically detected from sensing data collected by DFOS systems in real-time and paired with the GPS coordinates. As we shall show and describe, our inventive methods according to aspects of the present disclosure advantageously reduce false determinations caused by road traffic, field construction, electrical converters for traffic lights and other ambient and/or environmental noises/vibrations.

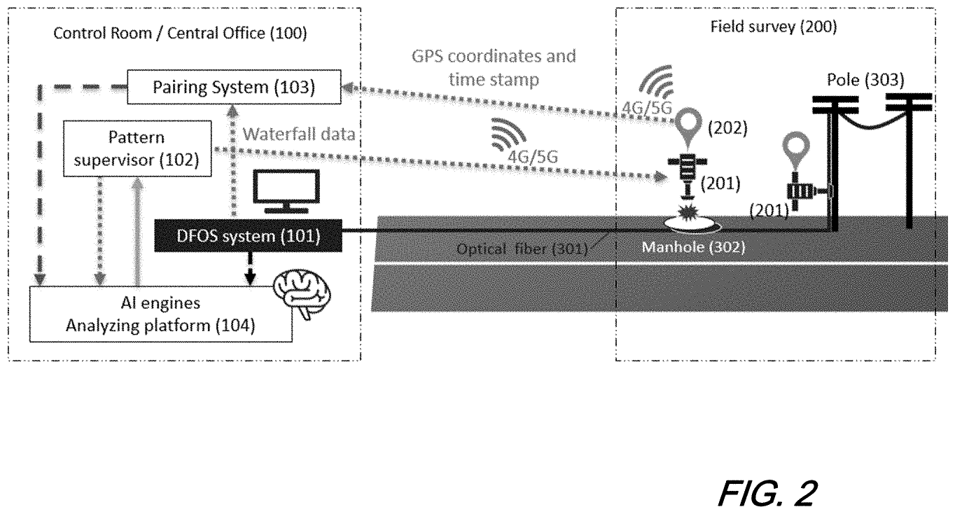

FIG. 2 is a schematic diagram showing an illustrative system layout of a sensing layer overlaid on an existing deployed optical fiber according to aspects of the present disclosure. As is shown in that figure, a distributed fiber optic sensing system (DFOS) (101) which can be a distributed acoustic sensing (DAS) and/or distributed vibration sensing (DVS) system is shown located in a control/central office (100) for remote monitoring of an entire fiber optic cable route. The DFOS system is connected to the field fiber optic cable—which serves as a continuous sensor—to provide sensing functions. Advantageously, the sensor fiber can be a dark fiber (no telecommunications traffic) or operational (telecommunications carrying) optical fiber provided and maintained by one of many possible service providers.

To determine a precise localization of a fiber optic cable, a field technician will use a vibrator (201) with connections to pattern recognizer (104) and a GPS device (202). As will be appreciated, any location along the length of the fiber optic cable route can be surveyed, such as location(s) close to the fiber cable (301), locations close to a manhole/hand hole/access hole (302) and locations close to poles (303). Usually, determining locations of manholes (302) and/or poles (303) is easier than determining locations of optical fiber cable (301)—which is oftentimes buried underground.

The GPS device (202) is used in coordination with the vibrator (201) and sends GPS coordinates to pairing system (103)—shown located in the CO—while vibrations are being generated. By matching/associating time stamps of the GPS device coordinates and the DFOS system data, a precise geographic location of a targeted location can be paired with fiber distance(s) determined from waterfall data and GPS coordinates. As we noted however, there are a number of ambient vibrations encountered in the field which may be confusingly similar to vibrator patterns generated by field vibrators (201). According to aspects of the present disclosure—to distinguish vibratory survey signals from environmental noise vibrations, a unique vibration pattern produced by the vibrator is employed. Accordingly, a pattern supervisor (102) which may be located in the CO communicates with the field vibrator (201) by digital cellular (e.g., 4G/5G) or other mechanisms and sends the patterns used in survey tests to the field vibrator—such patterns so used are called sequence patterns.

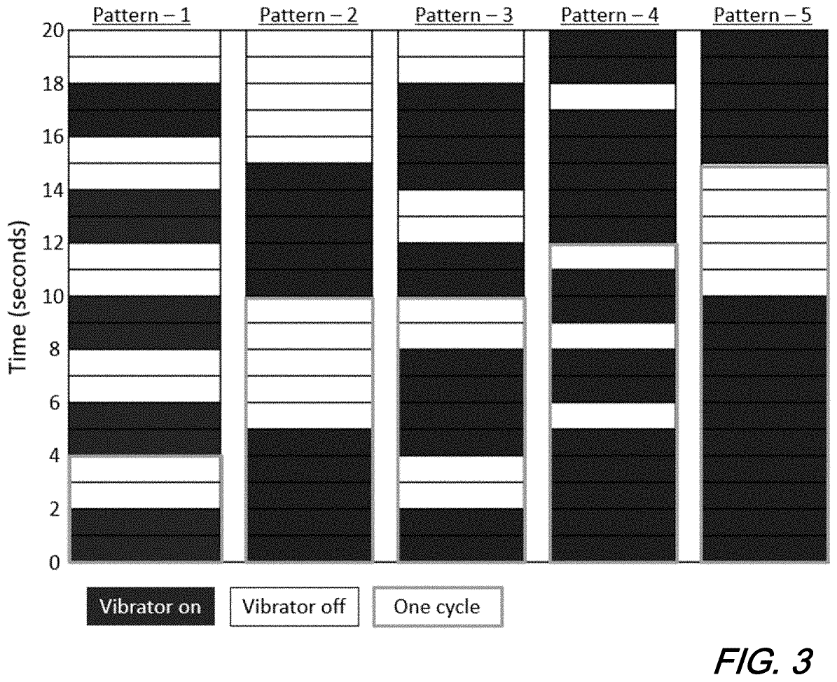

FIG. 3 is schematic diagram showing illustrative sequence patterns generated by a pattern supervisor and sending to a field vibrator according to aspects of the present disclosure. As may be observed in this figure, our inventive method uses different on/off time durations of the field vibrator to create different vibrator patterns that are applied to the sensor fiber. For example, (A) Pattern—1 (equally 2 seconds): 2 seconds of vibrator-on and 2 seconds of vibrator-off, (B) Pattern—2 (equally 5 seconds): 5 seconds of vibrator-on and 5 seconds of vibrator-off, (C) Pattern—3 (1-short/1-long): 2 seconds of vibrator-on, 2 seconds of vibrator-off, 5 seconds of vibrator-on and 2 second of vibrator-off, (D) Pattern—4 (1-long/2-short): 5 seconds of vibrator-on, 1 second of vibrator-off, 2 seconds of vibrator-on, 1 second of vibrator-off, 2 seconds of vibrator-on and 1 second of vibrator-off, etc. The sequence patterns are generated by AI analyzing platform (104) based on long-term ambient data collection. The sequence pattern is selected such that it is different from the encountered environmental noise and therefore easier to identified and distinguish during a field survey.

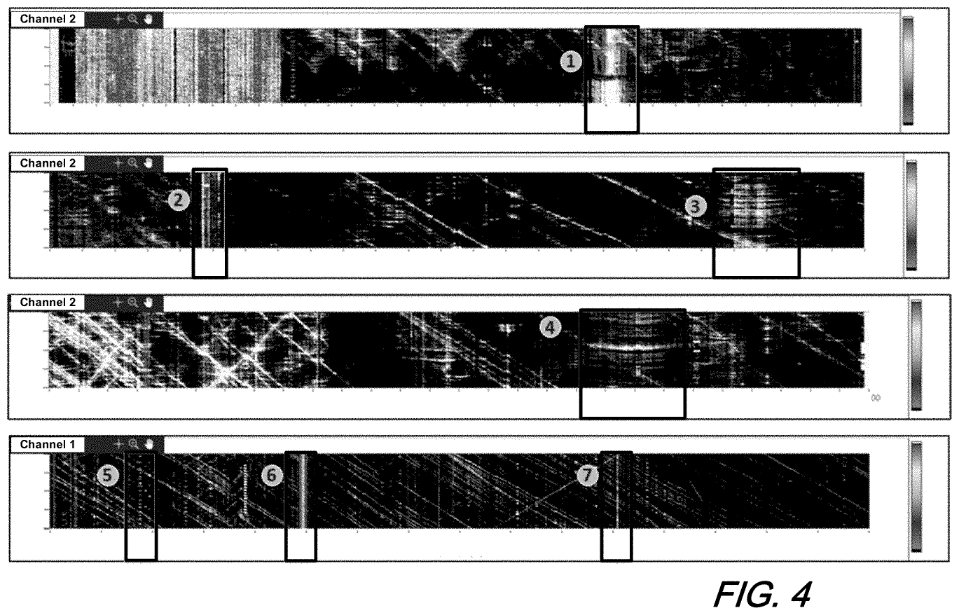

FIG. 4 shows a series of plots showing illustrative examples of field noise patterns according to aspects of the present disclosure. As those skilled in the art will understand and as we have previously mentioned, such field noise patterns may result from road construction involving rolling machines, digging machines, air compressors, passenger and/or transport vehicles—and other ambient noises or vibration sources that excite the sensor fiber.

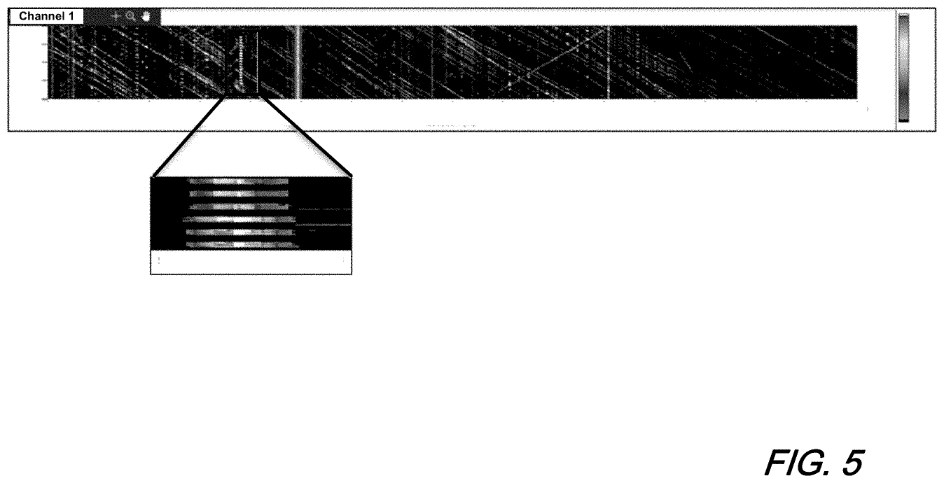

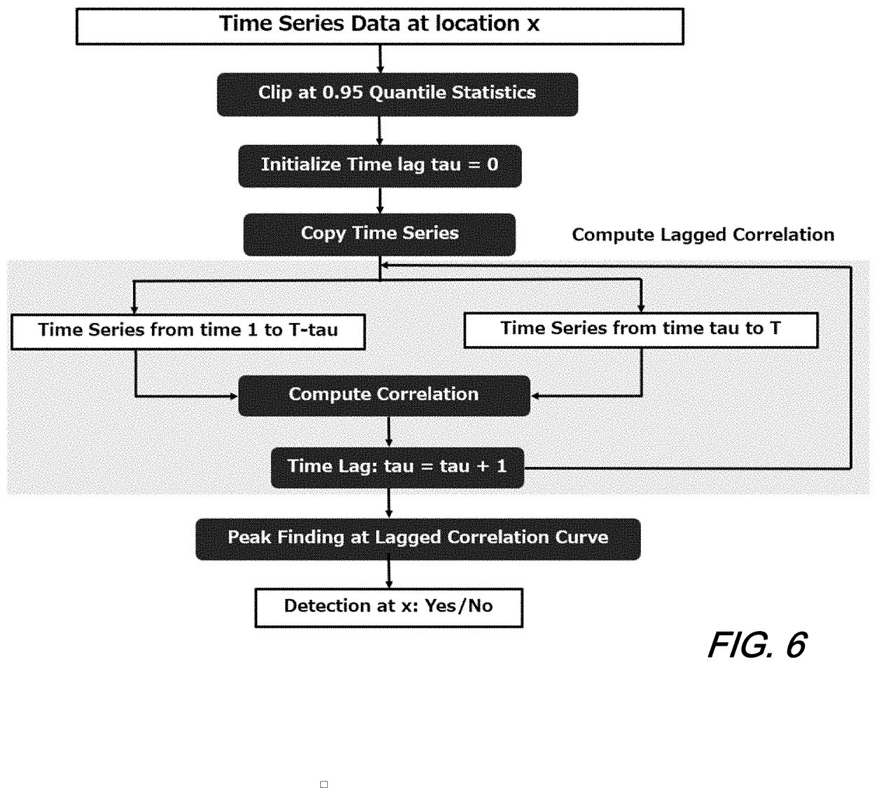

FIG. 5 is a plot showing an illustrative example of sequence pattern #1 of FIG. 4 according to aspects of the present disclosure. In order to evaluate the effectiveness of distinguishing survey vibrations and environmental noises, a sequence pattern (Pattern—1 (equally 2 seconds)) was tested in the field, and the results shown in this figure. In this scenario, our AI algorithms easily detected sequence patterns during the field survey and thereby eliminated false data. The illustrative AI algorithm employed for recognizing field vibrator on-off patterns (104) is detailed in FIG. 6 which is a schematic flow diagram showing an illustrative pattern recognizer according to aspects of the present disclosure.

With reference to this figure, we note that at each location x along the fiber route, the time series data is first truncated at 0.95 quantile statistics. This step can mitigate the influence from occasional spike noise and flatten the top of the signal pattern. The processed time series is split into two copies and shifted with offset tau, where tau=1, . . . , T. Similarity between the two is measured by cross-correlation.

In particular, the sample-based estimation of cross-correlation is as follows:

$${ρ}_{XY} ( τ ) = {{\sum }_{i = 1}}^{T - τ} ( {x}_{i} - {m}_{x} ) ( {x}_{τ + i} - {m}_{y} ) / {s}_{x} {s}_{y} \\ {m}_{x} = \frac{1}{T - τ} {{\sum }_{i = 1}}^{T - τ} {x}_{i} \\ {m}_{y} = \frac{1}{T - τ} {{\sum }_{i = τ}}^{T} {x}_{i} \\ {s}_{x} = \begin{matrix}\sqrt{\frac{1}{T - τ - 1} {{\sum }^{T - τ}}_{i = 1} {( {x}_{i} - {m}_{x} )}^{2}} \\ {s}_{y} = \sqrt{\frac{1}{T - τ - 1} {{\sum }_{i = τ}}^{T} {( {x}_{i} - {m}_{y} )}^{2}}\end{matrix}$$

Once the cross-correlations for all tau values are computed. A peak finding algorithm takes a 1-D array of cross-correlations as input and finds all local maxima by comparing to neighboring values. A subset of peaks are selected with minimum height 0.1 and minimal horizontal distance to be 10.

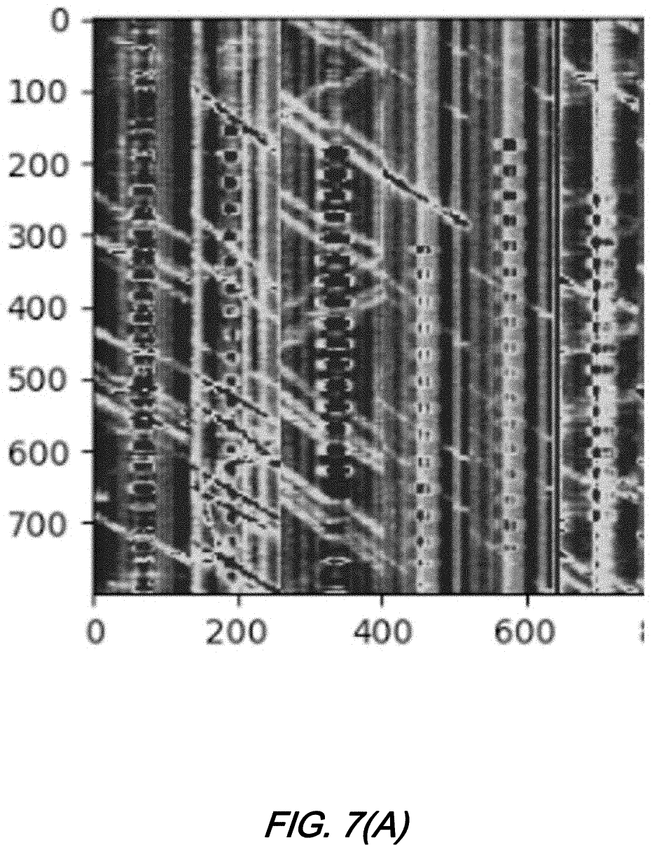

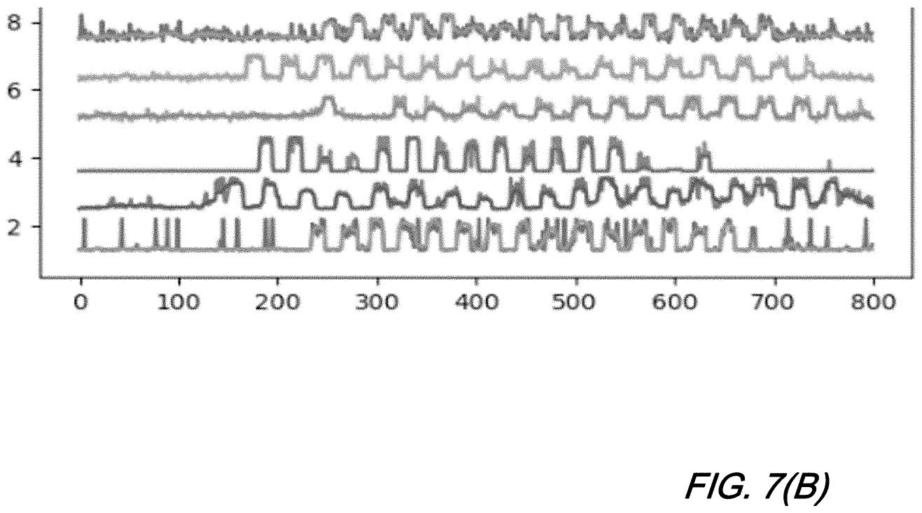

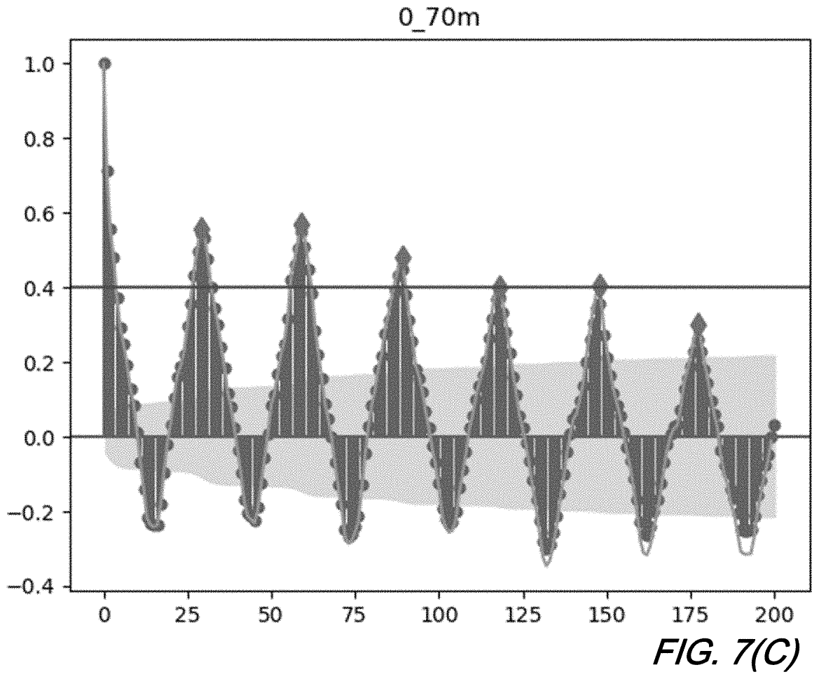

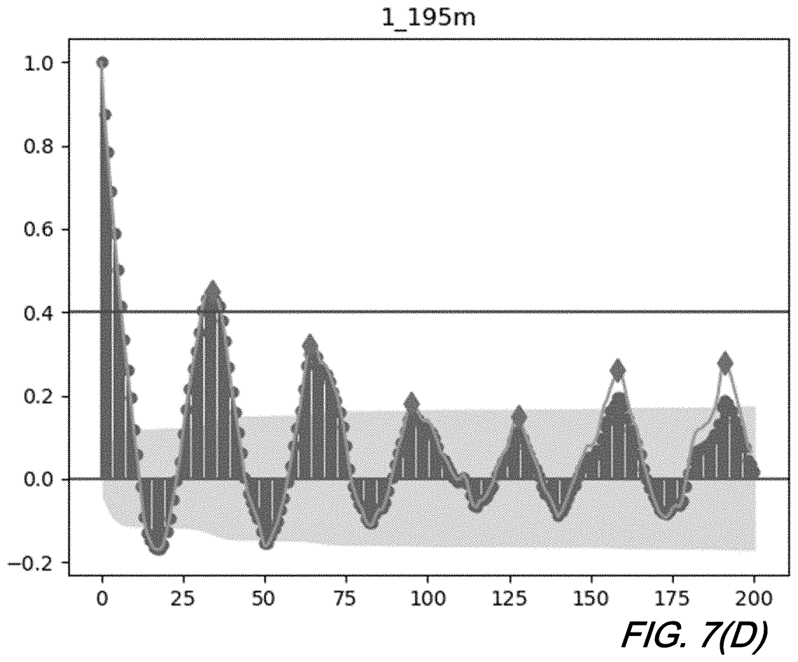

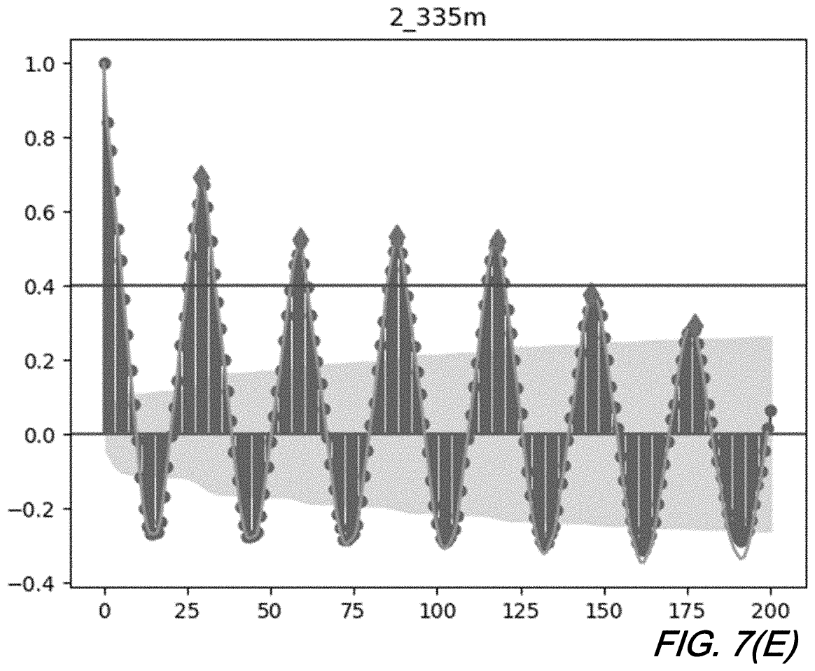

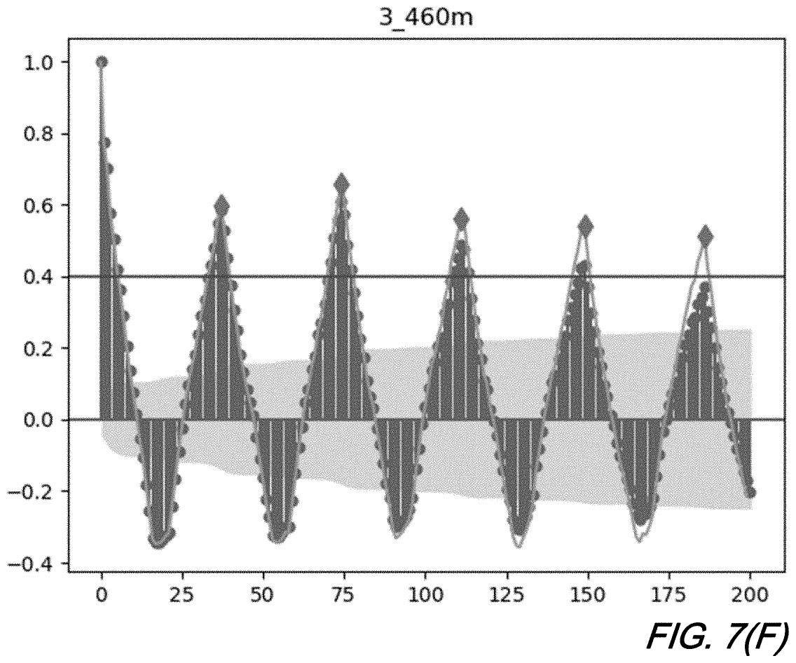

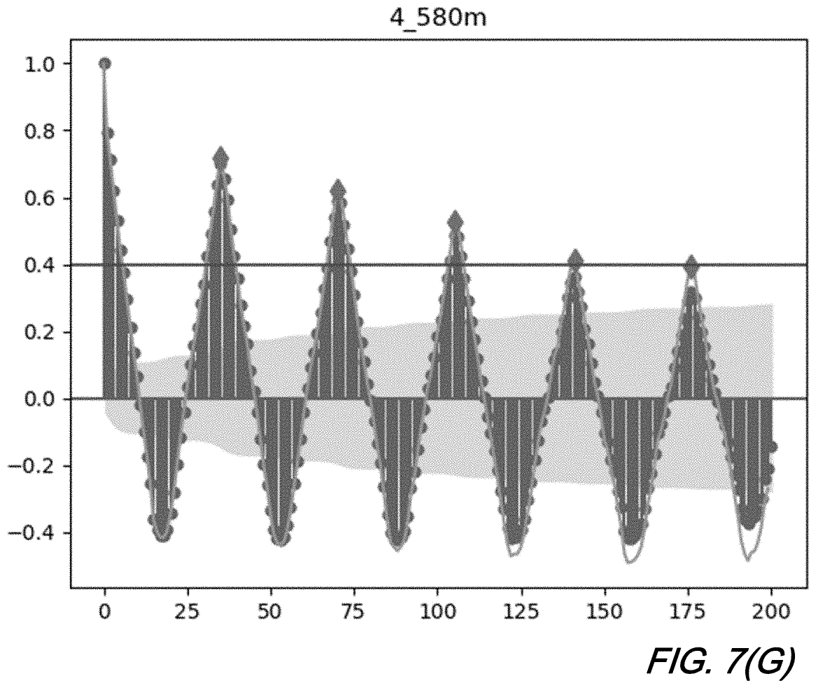

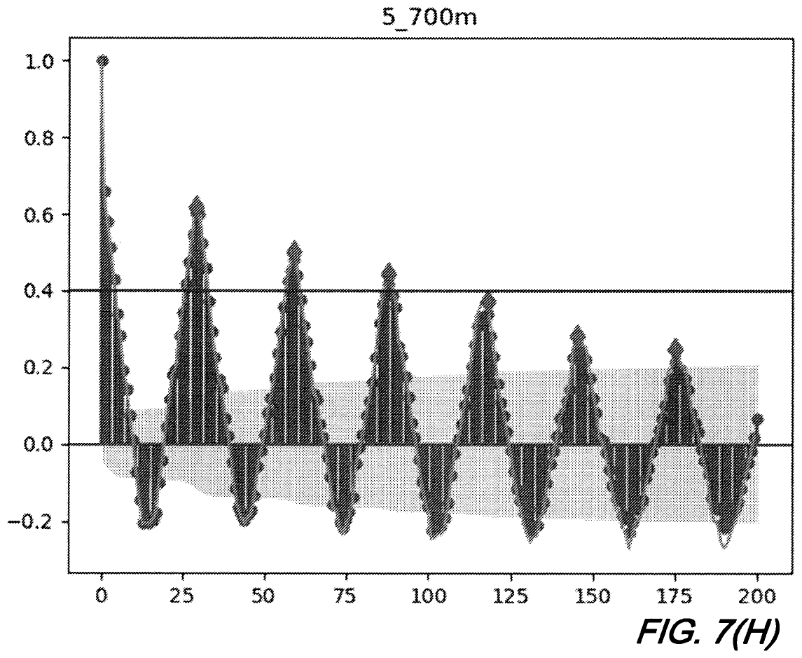

FIG. 7(A)-FIG. 7(H) are a series of detecting patterns from waterfall data in which FIG. 7(A) contains 6 target patterns; FIG. 7(B) shows time series before and after truncation; and cross correlation up to lag=200 is shown in FIG. 7(C)-FIG. 7(H) according to aspects of the present disclosure.

The cable location can be found by analyzing the peaks patterns. Due to the fluctuation of time laps, the average time gap between neighboring peaks is 28.8˜37.75, with standard deviation between 0 and 1.46. The number of peaks range from 5 to 8. This procedure has been found more effective than taking FFT on the time series as the frequency peaks are not as significant as cross-correlation peaks. Moreover, as compared to supervised learning methods, this method does not require data labeling and model training. It inherently relies on the self-similarity of vibrator patterns and thus is more robust than the prior art methods.

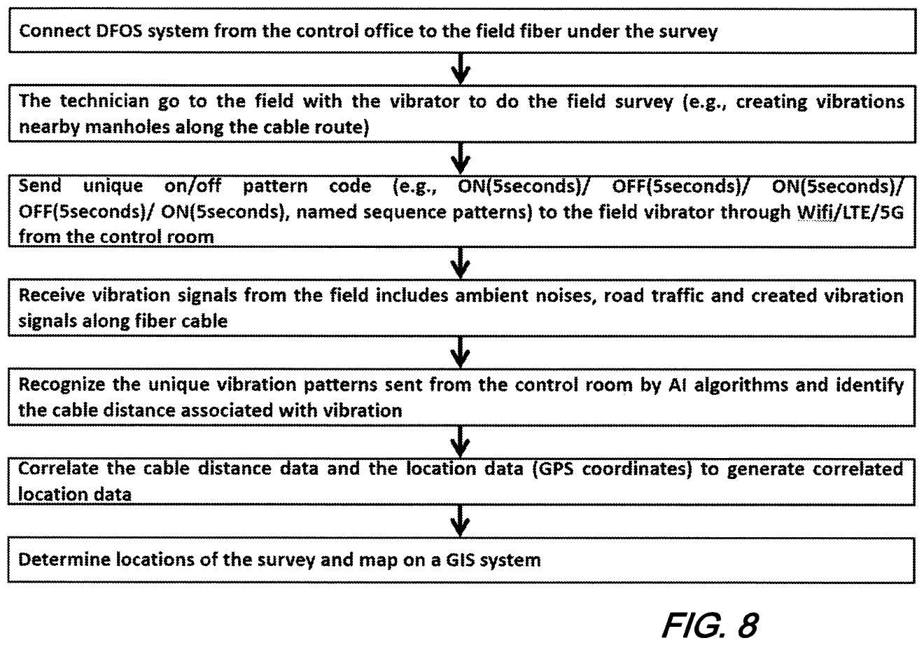

FIG. 8 is a schematic flow diagram showing an illustrative process according to aspects of the present disclosure.

At this point we may now describe variations to our inventive processes including new method(s) and systems that advantageously: reduce the laborious effort of collecting training data; easy DFOS system adjustment; simplifying fiber optic cable localization procedure; and improving the localization accuracy.

As noted, our existing methods disclosed still rely on field technicians/service personnel to deploy to field locations and generate/apply vibration signals to the fiber optic cable at locations along its length. As noted further, one major challenge for DFOS determination of fiber optic cable location is that generated/applied vibration signals created in-field by technicians need to be distinguishable from any ambient noise (e.g., compressor nearby, adjacent road construction etc.). As noted further, such signals may exhibit patterns similar to ones created by the field vibrator(s). While our machine learning methods for vibration localization are quite effective, in order to reduce false/incorrect estimations of distance, an amount of sensor data needs to be generated to train the machine learning model employed.

As such, one aspect of the present disclosure applies correlations from field vibrator generated signals collected by a mobile device and vibration signals collected by DFOS systems. As we shall describe, our inventive technique provides a high correlation location to determine geographic position of the vibrator location more precisely and repeatedly along the length of the sensor fiber.

As may be appreciated, several issues associated with these measurements include:

Field acoustic signals: Recording the acoustic signals of vibrator tamping the ground from the mobile device and send it back to the CO;

Field vibration signals: Collecting the vibration signals from the DFOS system;

Data pairing: Discovering the high correlation of the acoustic signals and vibration signals to determinate the vibrator location along the fiber route; and

Mapping: Pairing the GPS coordinates of the mobile device (location of the vibrator) and cable length on a map.

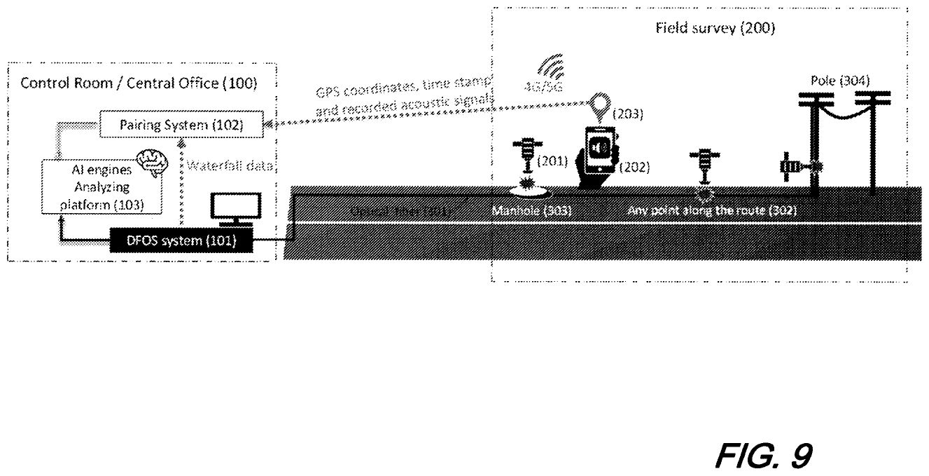

FIG. 9 is a schematic diagram showing an illustrative system layout of a sensing layer overlaid on an existing deployed optical fiber according to aspects of the present disclosure according to aspects of the present disclosure.

As may be observed, such an illustrative system is similar to that previously presented. The distributed fiber optic sensing system (DFOS) (101) can be a distributed acoustic sensing (DAS) system and/or distributed vibration sensing (DVS) system is shown located in the control office/central office (100) for remote monitoring of entire cable route. The DFOS system is connected to the optical sensor fiber (301) to provide sensing functions. Such fiber can be a dark fiber or operational fiber as provided by service providers.

In order to determine precise localizations of the fiber optic cable, field technicians will utilize a jackhammer (201) or other vibration-inducing device and a mobile device (202) such as a cellphone with 5G/LET services and voice recording functions (203).

Any location along the fiber route can be a location to do a survey, such as close to the fiber cable (302), manhole/hand hole/access hole (303) and poles (304). When the technician operates the jackhammer (201) to tamper the ground, the mobile device (202) sends the current GPS as well as recordings of noise generated by the jackhammer to paring system (102) located in the CO (100). In operation, the technician will operate the jackhammer intermittently and randomly thereby creating a random noise pattern. By searching the correlations between acoustic signals from the mobile device and vibration signals collected by DFOS, the location of a targeted location along the sensor fiber can be paired with fiber distance from waterfall data and GPS coordinates obtained from the mobile device.

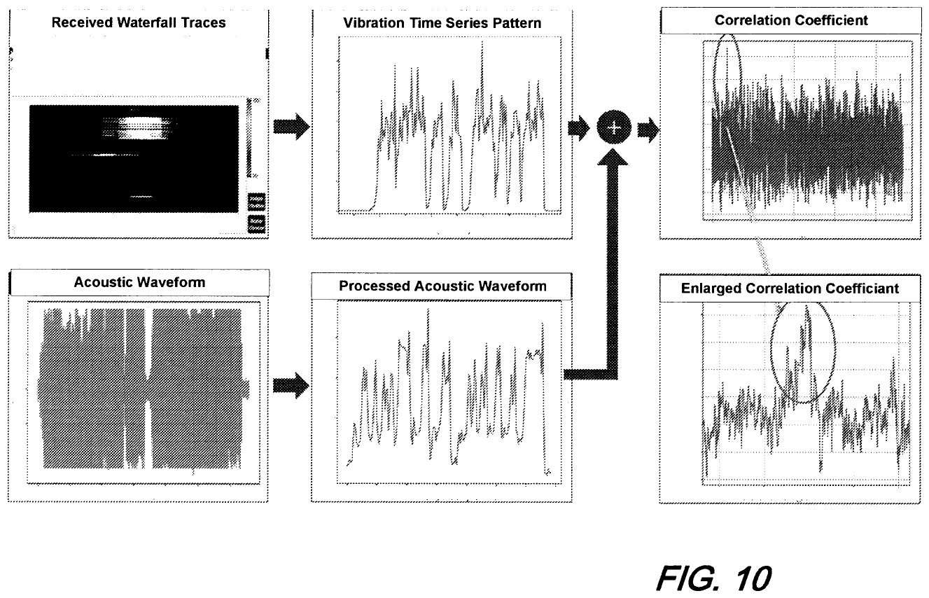

FIG. 10 is a schematic diagram illustrating a method according to aspects of the present disclosure employing acousto-vibration correlation cable localization. As may be observed from the figure After a technician creates vibration using the jackhammer in the field, there are two signals received in the CO, namely waterfall traces collected by the DFOS system and acoustic waveforms collected by the mobile device. By processing the waterfall traces in vibration time-series pattern and down sampling the mean root square of the waveform, the location of the highest correlation coefficient can be discovered as shown for entire route and for enlarged section. Based on the high correlation, the location of the jackhammer can be paired with cable length information from the DFOS system. With GPS coordinates from the mobile device, the geographic position can be known as well and mapped on a graphical information system (GIS).

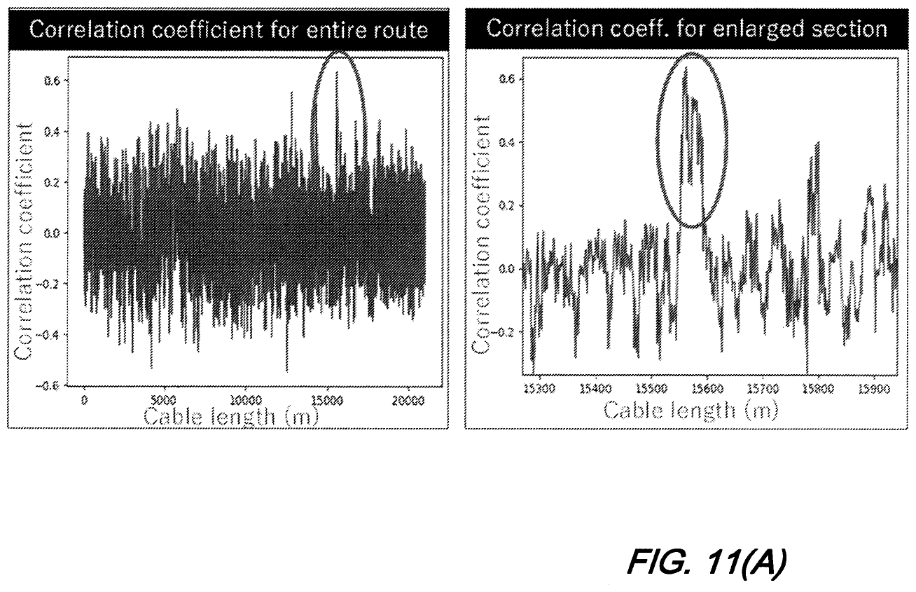

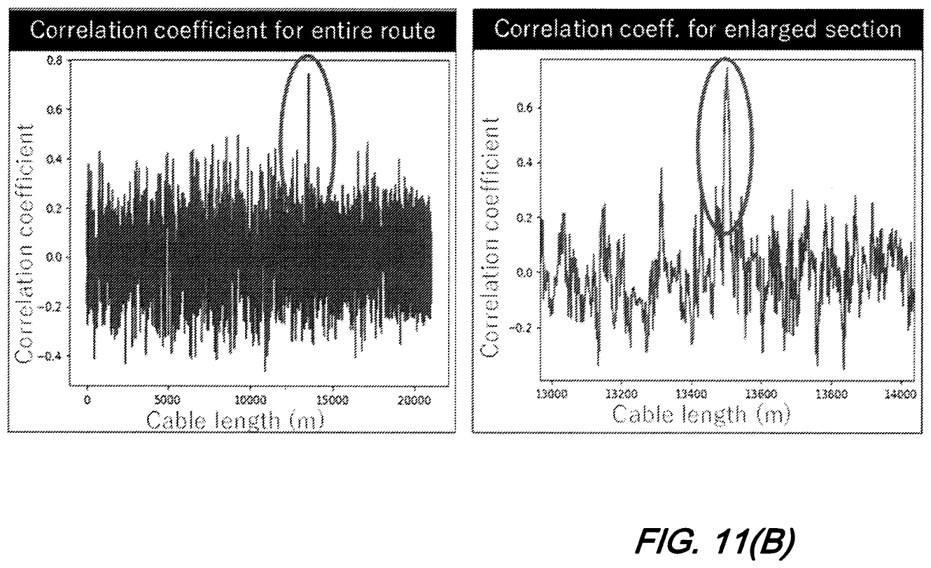

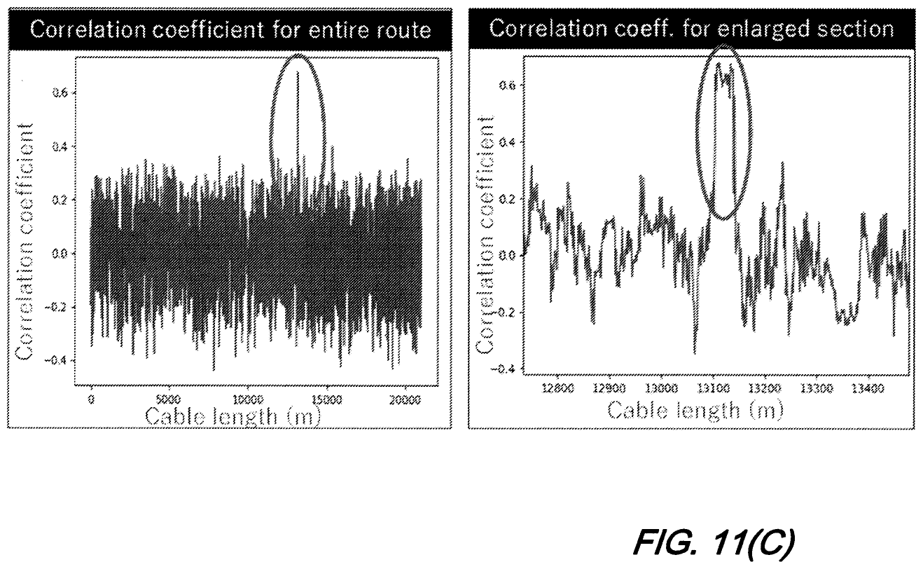

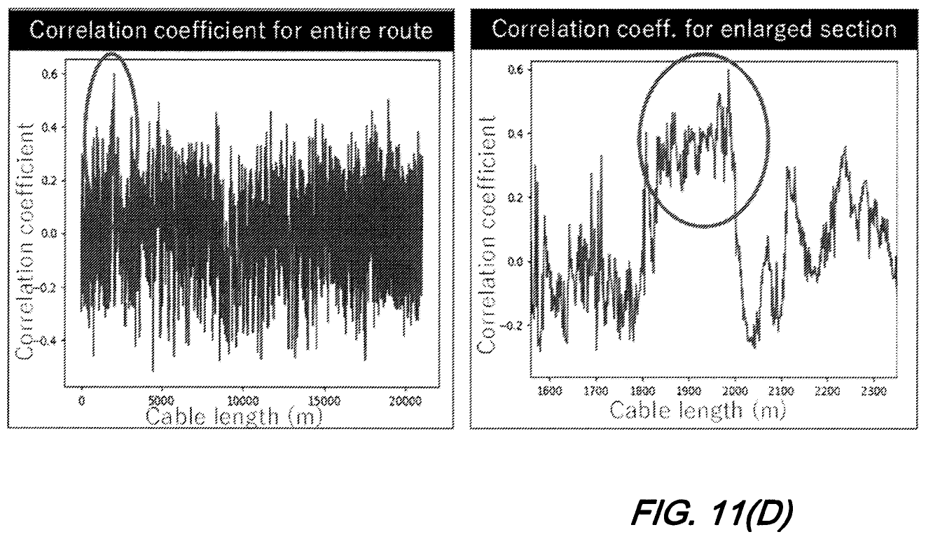

FIG. 11 (A)-FIG. 11(D) are plots illustrating field testing results according to aspects of the present disclosure. With reference to these figures, we note that FIG. 11(A) plot results from jackhammer vibrations in a quiet location with low ambient noise such as road traffic, FIG. 11(B) plot results from a location with weak signal region, FIG. 11(C) plot results from a busy location with dense road traffic and FIG. 11(D) plots results from hitting a pole and receiving vibration signals from an aerial cable section of the fiber optic cable.

It can be seen from these plots that the proposed technique is capable of buried cable localization even in a dense traffic section and a weak response area. In FIG. 11(D), the high correlation coefficient area is wide resulting from jackhammer created strong vibrations to the pole and aerial cable, that affect a wider area. The location of the pole can be found, but not precisely. It can be improved by using a lighter vibration source or using a rubber hammer impart vibrational excitations to the pole during the localization tests.

As may now be appreciated, several benefits of our inventive method include:

Reducing AI resources: There is no need to have pre-collected data for AI training. No more pre-trained AI models which can reduce the processing resources.

Easy field operations: Field technicians can turn on/off the Jackhammer randomly to create a non-defined patterns having vibration periods of only a few seconds in length/duration.

Robustness: The method produces very robust result, even with the strong background noise, like traffic noise from the site, or the strong background associated with suspended/aerial cable etc.

High accuracy: High accuracy can be achieved with extremely low false positive rate.

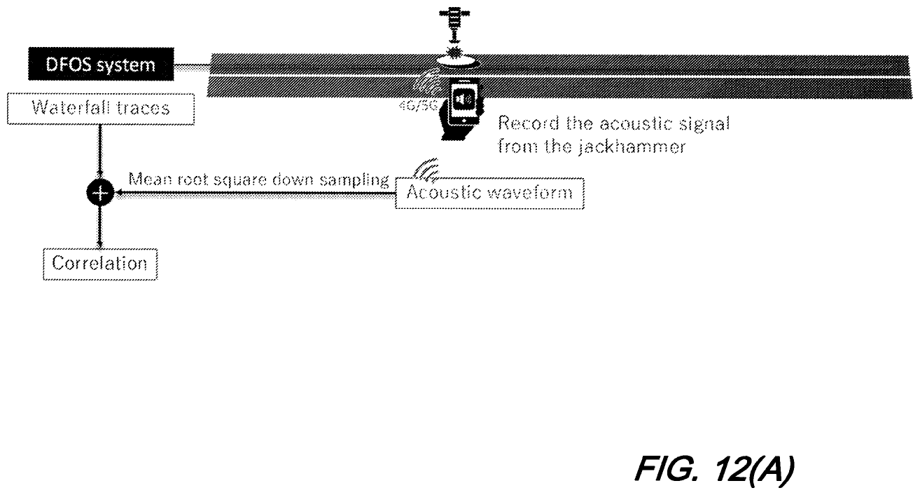

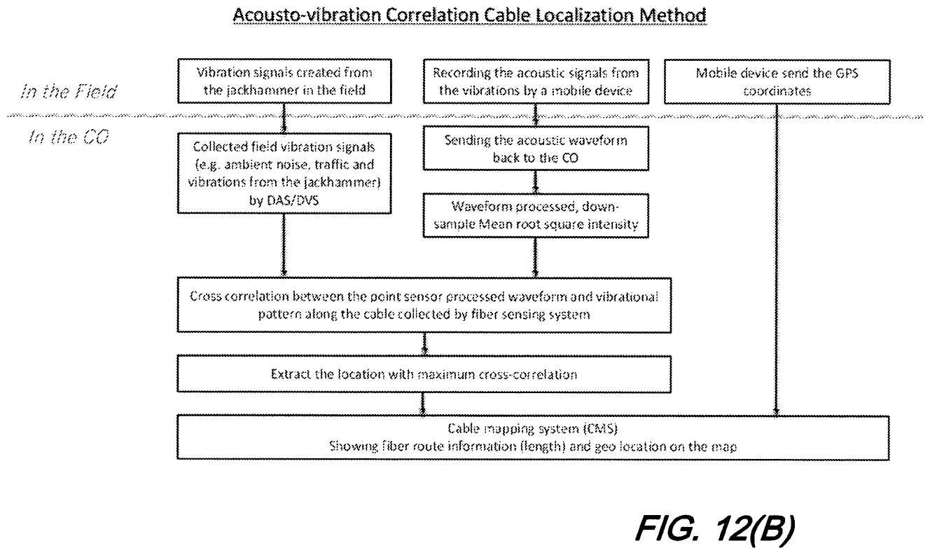

FIG. 12(A) is a schematic diagram illustrating system operation according to aspects of the present disclosure.

FIG. 12 (B) is a schematic diagram illustrating acousto-vibration correlation cable localization method according to aspects of the present disclosure.

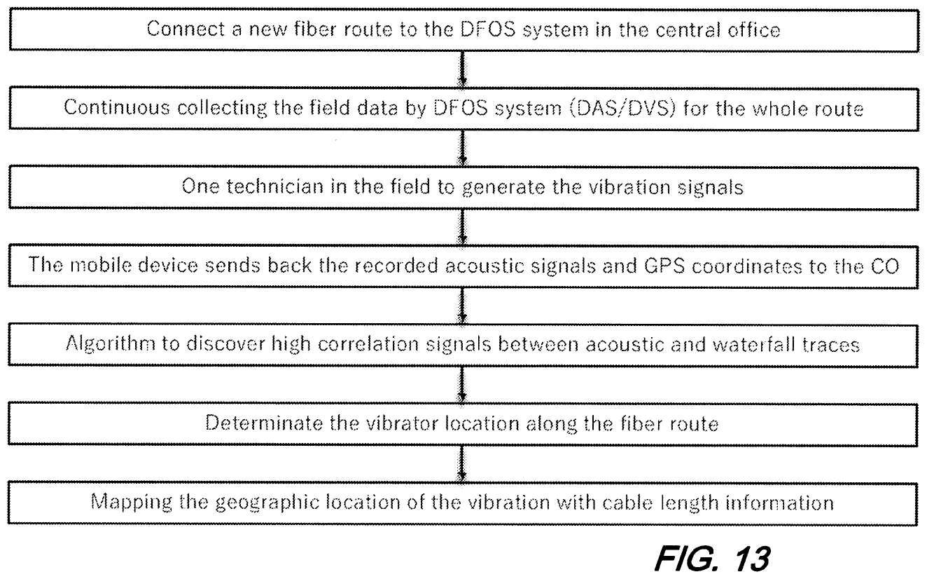

FIG. 13 is a schematic flow diagram showing an illustrative process according to aspects of the present disclosure.

At this point, those skilled in the art will understand and appreciate that our inventive systems and methods may advantageously employ DAS systems to distinguish between authorized and unauthorized events on an optical fiber and logs repair events while reducing false alerts.

One aspect of our inventive systems and methods includes a handheld device similar to an electric toothbrush that has a handle and a vibrating portion. Before a technician performs maintenance on an optical fiber network, she enters a code to the device, and initiates contact of the vibrating part of the device to the fiber. Once turned on, the device generates a vibration pattern unique to the (authorized) technician. The specific vibration of the device applied to the fiber is detected and localized remotely by the DAS system. This event is registered appropriately as an authorized repair work (and the vibration code will be logged as well, so the ID of the technician, the time and the location of the technician will be recorded as well). Also, the DAS will register that location as ‘under construction’ and any vibration at that location after this time will not be registered as an intrusion events and eliminate false alarms.

Once the repair is completed the technician can again generate the vibration code to signal that the repairs are completed and she is leaving the repair location. Once again, the DAS can register the end of the repair and terminate the ‘under construction’ mode for that location and continue its normal operation for this location. As will be appreciated, our inventive operation informs the DAS system that an authorized technician is about to perform repairs and 1—confirms authorized technician, 2—prevents false alarms during repair, 3—logs all the details regarding the repair (who?, when?, where?, what?).

As is known, a DAS system is a very sensitive sensor that can monitor a long optical fiber in real-time and record and analyze any vibrations that excite the fiber which are detected by an interrogator/analyzer in communication with the fiber. Our inventive coded vibration device generates a unique identification vibration pattern and allows identification of an authorized maintenance operation and user/technician through the controlled, unique identification vibration.

As will be appreciated, our inventive technique includes: Generating a unique code for each technician and the type of work; Transforming the unique code to a vibration pattern; Communicating with the DAS through the fiber cable (via vibration) and NOT through wireless or any other RF network; and identify locations along the length of the optical sensor fiber so excited as ‘under construction’ and neglect abnormal events during repairs and reducing false alarms. Once such authorized work is completed, a vibratory “work complete/done” code may be applied to the sensor fiber to indicate to the DAS that an affected portion of the sensor fiber is now operational. Those skilled in the art will understand and appreciate that any number of vibratory codes may be so applied indicative of various status conditions of particular length(s) of the optical sensor fiber.

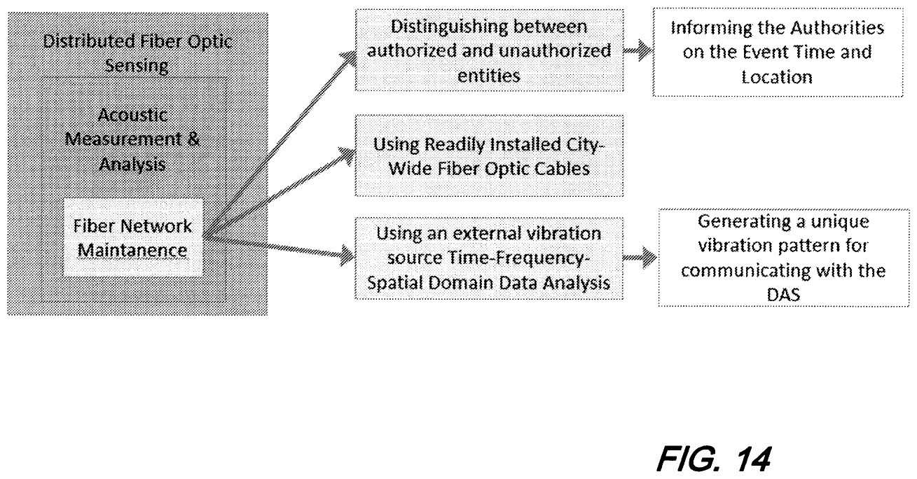

FIG. 14 is a schematic block diagram showing an illustrative features of a method according to aspects of the present disclosure.

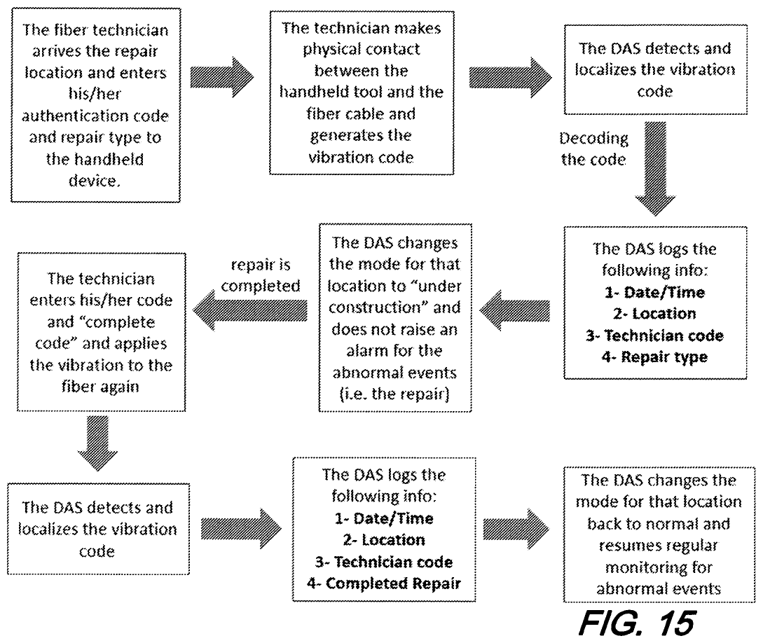

FIG. 15 is a schematic block diagram showing illustrative features and relationships of a process according to aspects of the present disclosure;

At this point, while we have presented this disclosure using some specific examples, those skilled in the art will recognize that our teachings are not so limited. Accordingly, this disclosure should be only limited by the scope of the claims attached hereto.

1. A method for identification of location of deployed fiber cable using distributed fiber optic sensing (DFOS), the method comprising:
providing a distributed fiber optic sensing system (DFOS), said system including a length of optical sensor fiber; and
a DFOS interrogator and analyzer in optical communication with the length of optical fiber, said DFOS interrogator configured to generate optical pulses from laser light, introduce the pulses into the optical fiber and detect/receive Rayleigh reflected signals from the optical fiber, said analyzer configured to analyze the Rayleigh reflected signals and generate location/time waterfall plots from the analyzed Rayleigh reflected signals;
a sequencer and pattern supervisor configured to create sequence patterns and provide the created sequence patterns to a mechanical vibrator;
operating the mechanical vibrator at a location along the length of optical fiber, the mechanical vibrator configured to receive the created sequence patterns and generate mechanical vibrations according to the received sequence pattern, apply the generated mechanical vibrations to the optical fiber, and determine the global positioning location (GPS) location of the mechanical vibrator during operation and transmit GPS coordinates and time stamp information to the DFOS interrogator and analyzer;
operating the DFOS system while providing the generated mechanical vibrations to the optical fiber thereby producing vibration events in the optical fiber and recording DFOS signals received during operation while associating optical fiber location to GPS coordinates and time stamp information received from the mechanical vibrator.

2. The method of claim 1 wherein the DFOS system/analyzer is further configured to pair received GPS coordinates to optical fiber length and adjust created sequence patterns according to the pairing.

3. The method of claim 2 wherein the DFOS system/analyzer is further configured to report a target location with GPS coordinates and optical fiber length.

4. The method of claim 3 wherein the DFOS system/analyzer is further configured to generate a map having the target location with GPS coordinates and optical fiber length identified.

5. The method of claim 4 wherein at least a portion of the optical fiber is buried underground.

6. The method of claim 5 wherein the mechanical vibrator is configured to receive sequence patterns via cellular telephone signals including 4G and 5G signals.

5. The method of claim 4 wherein the automatic determination includes operating a machine vision system that examines the waterfall plots.

6. The method of claim 3 wherein the DFOS system/analyzer is configured to associate the received GPS coordinates, time information, and optical fiber length to a generated sequence pattern.

7. The method of claim 1 wherein the sequence pattern is associated with an individual service technician operating the mechanical vibrator.

8. A method for identification of location of deployed fiber cable using distributed fiber optic sensing (DFOS), the method comprising:
providing a distributed fiber optic sensing system (DFOS), said system including a length of optical sensor fiber; and
a DFOS interrogator and analyzer in optical communication with the length of optical fiber, said DFOS interrogator configured to generate optical pulses from laser light, introduce the pulses into the optical fiber and detect/receive Rayleigh reflected signals from the optical fiber, said analyzer configured to analyze the Rayleigh reflected signals and generate location/time waterfall plots from the analyzed Rayleigh reflected signals;
reception and pairing circuitry configured to receive GPS coordinates, time stamp information, and recorded acoustic signals from a mobile device;
operating the mechanical vibrator at a location along the length of optical fiber, the mechanical vibrator configured to generate mechanical vibrations and apply the generated mechanical vibrations to the optical fiber;
operating the mobile device proximate to the mechanical vibrator, the mobile device configured to record acoustic signals, and transmit the GPS coordinates, time stamp information, and recorded acoustic signals to the reception and pairing circuitry;
operating the DFOS system while providing the generated mechanical vibrations to the optical fiber thereby producing vibration events in the optical fiber and recording DFOS signals received during operation while associating optical fiber location to GPS coordinates, time stamp information, and recorded acoustic signals received from the mobile device.

9. The method of claim 8 further comprising correlating waterfall traces generated by the DFOS system with acoustic signals received from the mobile device.

10. The method of claim 8 wherein the correlating further comprises down-sampling mean root square intensity of the received acoustic signals.
